(19) United States
(12) Patent Application Publication
(10) Pub. No.: US 2013/0027013 A1
(43) Pub. Date: Jan. 31, 2013

(54) ERROR VOLTAGE GENERATION CIRCUIT, SWITCH CONTROL CIRCUIT COMPRISING THE SAME, AND POWER FACTOR CORRECTOR COMPRISING THE SWITCH CONTROL CIRCUIT

(71) Applicants: Jae-Yong LEE, Seongnam (KR); Young Bae PARK, Anyang (KR); Young-Je LEE, Bucheon (KR); Ho Jae LEE, Seoul (KR)

(72) Inventors: Jae-Yong LEE, Seongnam (KR); Young Bae PARK, Anyang (KR); Young-Je LEE, Bucheon (KR); Ho Jae LEE, Seoul (KR)

(21) Appl. No.: 13/542,015

(22) Filed: Jul. 5, 2012

(30) Foreign Application Priority Data
Jul. 25, 2011 (KR) 10-2011-0073746

(51) Int. Cl. G05F 1/10

(52) U.S. Cl. 323/283

(57) ABSTRACT

The present invention relates to an error voltage generation circuit, a switch control circuit, and a power factor corrector. The error voltage generation circuit generates an error voltage using an error input voltage corresponding to an output voltage of a power factor corrector and a soft start voltage. The error voltage generation circuit samples an error input voltage at an AC input supply time point of the power factor corrector and holes a sampling voltage according to the sampled error input voltage during a soft start period. The error voltage generation circuit generates a soft start voltage increasing from a start voltage corresponding to the sampling voltage. The switch control circuit controls a duty of a power switch of the power factor corrector using the error voltage.

### CROSS-REFERENCE TO RELATED APPLICATION

This application claims priority to and the benefit of Korean Patent Application No. 10-2011-0073746 filed in the Korean Intellectual Property Office on Jul. 25, 2011, the entire contents of which are incorporated herein by reference.

### BACKGROUND OF THE INVENTION

(a) Field of the Invention

The present invention relates to an error voltage generation circuit, a switch control circuit including the error voltage generation circuit, and a power factor corrector including the switch control circuit.

(b) Description of the Related Art

When an AC input to a power factor corrector is blocked and then supplied, the power factor corrector is soft-started. The soft start prevents an over-shoot due to an increase of a drain current at an operation start time of the power factor corrector.

The power factor corrector controls a switching operation according to a difference between a feedback voltage corresponding to an output voltage an a predetermined reference voltage. During a soft start period, the reference voltage is gradually increased.

In further detail, during the soft start period of the power factor corrector, the reference voltage may be increased with a constant slope from a predetermined start voltage to a predetermined expiring voltage or may be increased in a stepwise pattern. During the soft start period of the power factor corrector, a switching operation cannot be performed during a period that the feedback voltage is higher than the reference voltage.

An output voltage is determined according to a load connected to the power factor corrector at an AC input blocking time. When the AC input is supplied and thus the power factor corrector is soft-started, the feedback voltage corresponding to the output voltage at the AC input blocking time may be higher than the reference voltage.

Then, the switching operation is not performed for a period during which the reference voltage becomes higher than the feedback voltage from the soft start time. In addition, since the feedback voltage is determined according to the load at the AC input blocking time, a period during which the switching operation is not performed is changed when the load at the AC input blocking time is changed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention is objected to remove a period during which a switching operation is not performed during a soft start period and to maintain a constant soft start period without regard to the size of a load.

An error voltage generation circuit generating an error voltage using an error input voltage corresponding to an output voltage of a power factor corrector according to an exemplary embodiment of the present invention includes a sampling/holding unit sampling an error input voltage at a supply time point of an AC input to the power factor corrector and holding a sampling voltage according to the sampled error input voltage during a soft start period and a digital-analog converter (DAC) generating a soft start voltage increasing from a start voltage corresponding to the sampling voltage.

The error voltage generation circuit further includes a soft start controller being synchronized at the AC input supply time point or at an operation start time point of the power factor corrector and generating a count signal counting the soft start period. The DAC generates a soft start voltage increasing from the start voltage to a predetermined expiring voltage according to the count signal during the soft start period.

The error voltage generation circuit further includes a reference voltage generator receiving the start voltage and generating a plurality of reference voltages between the start voltage and the expiring voltage, and the DAC selects the start voltage, the plurality of reference voltages, and the expiring voltage according to the count signal during the soft start period. The soft start controller generates the count signal by counting a predetermined soft clock signal.

The soft start controller includes: a timer synchronized at the AC input supply time point or the operation start time point of the power factor corrector and generating the count signal by counting the soft clock signal; and a D flip-flop synchronized at the AC input supply time point or the operation start time point of the power factor corrector and activating the sampling/holding unit.

The D flip-flop generates a first control signal and a second control signal that control a sampling operation of the sampling/holding unit during the soft start period, and the sampling/holding unit blocks the error input voltage according to the second control signal, generates the sampling voltage, and changes an input of the sampling/holding unit to a predetermined first reference voltage according to the first control signal.

The sampling/holding unit includes: a first switch performing a switching operation according to the first control signal and having a first end connected to the first reference voltage; a second switch performing a switching operation according to the second control signal and having a first end connected to the error input voltage; a first capacitor having a first end connected to a second end of the first switch and a second end of the second switch; an error amplifier including a first input terminal connected to the second end of the first capacitor and a second input terminal to which a second reference voltage is input; a second capacitor connected between an output terminal and the first input terminal of the error amplifier; and a third switch connected between the output terminal and the first input terminal of the error amplifier. A voltage of the output terminal of the error amplifier is the sampling voltage.

The D flip-flop generates a control signal that controls the sampling operation of the sampling/holding unit during the soft start period, and the sampling/holding unit blocks the error input voltage according to the control signal and generates the sampling voltage.

The sampling/holding unit includes a switch performing the switching operation according to the control signal and having a first end connected to the error input voltage and a capacitor including a first end connected to a second end of the switch. The sampling voltage is a voltage of the first end of the capacitor.

The reference voltage generator includes a resistor row formed of a plurality of resistor coupled in series between a first end to which the start voltage is input and a terminal where the expiring voltage is generated.

The DAC selects a corresponding voltage among voltages of a plurality of nodes formed in the resistor row according to the count signal.

The error voltage generation circuit further includes a power factor correction error amplifier generating an error signal according to a difference between the soft start voltage and the error input voltage.

A switch control circuit according to another exemplary embodiment of the present invention receives an AC input and controls an operation of a power switch of a power factor corrector that generates an output voltage. The switch control circuit includes: an error voltage generation circuit sampling and holding an error input voltage corresponding to the output voltage at an AC input supply time point after the AC input is blocked or an operation start time point of the power factor corrector and generating an error voltage according to a difference between a soft start voltage increasing to a predetermined expiring voltage from a start voltage according to the sampled error input voltage and the error input voltage during a soft start period; and a PWM comparator controlling a duty of the power switch using the error voltage.

The error voltage generation circuit includes a sampling/holding unit sampling an error input voltage at the AC input supply time point and holding a sampling voltage according to the sampled error input voltage during the soft start period and a digital to analog converter (DAC) generating a soft start voltage increasing from a start voltage corresponding to the sampling voltage.

The error voltage generation circuit further includes a soft start controller controlling the sampling operation by being synchronized at the AC input supply time or the operation start time point of the power factor corrector and generating a count signal counting the soft start period. The DAC generates a soft start voltage increasing from the start voltage to a predetermined expiring voltage according to the count signal during the soft start period.

The error voltage generation circuit further includes a reference voltage generator receiving the start voltage and generating a plurality of reference voltages between the start voltage and the expiring voltage, and the DAC selects the start voltage, the plurality of reference voltages, and the expiring voltage according to the count signal during the soft start period. The soft start controller generates the count signal by counting a predetermined soft clock signal.

The soft start controller includes a timer synchronized at the AC input supply time point or the operation start time point of the power factor corrector and generating the count signal by counting the soft clock signal and a D flip-flop synchronized at the AC input supply time point or the operation start time point of the power factor corrector to activate the sampling/holding unit.

A power factor corrector according another exemplary embodiment of the present invention generates an output voltage by receiving an AC input. The power factor corrector includes: an inductor to which an input voltage rectified from the AC input; a power switch connected to the inductor to control generation of the output voltage; and a switch control circuit sampling and holding an error input voltage corresponding to the output voltage at the AC input supply after the AC input is blocked or the operation start time point of the power factor corrector, generating an error voltage according to a difference between a soft start voltage including from a start voltage according to the sampled error input voltage to a predetermined expiring voltage and the error input voltage, and controlling a duty of the power switch using the error voltage.

The switch control circuit includes a sampling/holding unit sampling an error input voltage at the AC input supply time point and holding a sampling voltage according to the sampled error input voltage during the soft start period and a digital to analog converter (DAC) generating a soft start voltage increasing from a start voltage corresponding to the sampling voltage.

The switch control circuit further includes a soft start controller controlling the sampling operation by being synchronized at the AC input supply time point or the operation start time point of the power factor corrector and generating a count signal counting the soft start period. The DAC generates a soft start voltage increasing from the start voltage to a predetermined expiring voltage according to the count signal during the soft start period.

The switch control circuit further includes a reference voltage generator receiving the start voltage and a plurality of reference voltage between the start voltage and the expiring voltage. The DAC selects the start voltage, the plurality of reference voltage, and the expiring voltage according to the count signal during the soft start period, and the soft start controller generates the count signal by counting a predetermined soft clock signal.

The present invention provides an error voltage generation circuit removing a period during which a switching operation is not performed during a soft start period, a switch control circuit including the error voltage generation circuit, and a power factor corrector including the switch control circuit.

### BRIEF DESCRIPTION OF THE DRAWINGS

FIG. 1 shows a power factor corrector according to an exemplary embodiment of the present invention.

FIG. 2 shows a switch control circuit according to an exemplary embodiment of the present invention.

FIG. 3 shows an error voltage generation circuit according to an exemplary embodiment of the present invention.

FIG. 4 shows a sampling/holding unit according to the exemplary embodiment of the present invention.

FIG. 5 shows a soft start controller according to the exemplary embodiment of the present invention.

FIG. 6 is a waveform diagram of signals of the error voltage generation circuit according to the exemplary embodiment of the present invention.

FIG. 7 is an exemplary variation of the sampling/holding unit according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Further, in the specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

The present invention will be described more fully hereinafter with reference to the accompanying drawings, in which exemplary embodiments of the invention are shown.

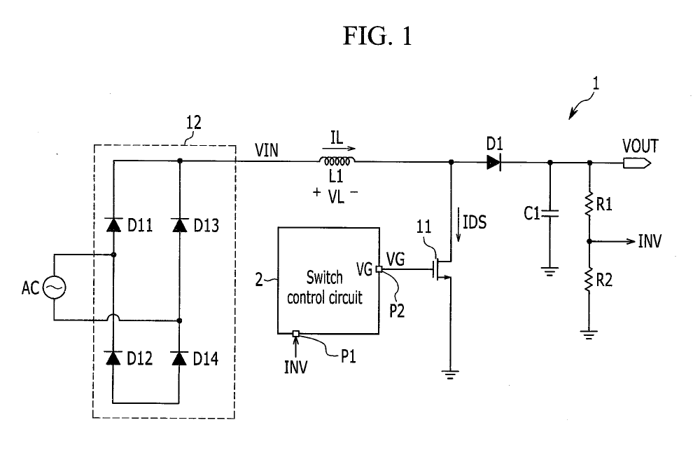

FIG. 1 shows a power factor corrector according to an exemplary embodiment of the present invention. The power factor corrector according to the exemplary embodiment of the present invention is realized as a boost converter. However, the present invention is not limited thereto.

As shown in FIG. 1, a power factor corrector 1 includes a switch control circuit 2, a power switch 11, a bridge diode 12, a diode D1, a capacitor C1, an inductor L, and division resistors R1 and R2.

The power switch 11 according to the exemplary embodiment of the present invention is formed of an n-channel metal oxide semiconductor field effect transistor (NMOSFET). A current flowing to the power switch 11 will be referred to as a drain current IDS.

The bridge diode 12 is formed of four diodes D11 to D14, and generates an input voltage Vin by full-wave rectifying input AD power. An output end of the bridge diode 12 is connected to a first end of the inductor L.

The first end of the inductor L is supplied with the input voltage Vin and a second end of the inductor L is connected to an anode of the diode D1 and a drain electrode of the power switch 11. A cathode of the power switch 11 is grounded, and a gate voltage VG output from the switch control circuit 2 is transmitted to a gate electrode of the power switch 11.

The input voltage Vin is transmitted to the inductor L, and output voltage is generated by a current (hereinafter, referred to as an inductor current) IL flowing to the inductor L by the input voltage VIN. The inductor current IL is controlled by a switching operation of the power switch 11.

During a turn-on period of the power switch 11, the inductor current IL is increased and the inductor L stores energy. During a turn-off period of the power switch 11, the inductor current IL flows through the diode D1 and the energy stored in the inductor L is transmitted to an output end of the power factor corrector 1.

When the power switch 11 is turned off and the diode D1 is connected, the inductor current IL flows to a load connected to the output end of the power factor corrector 1 and charges the capacitor C1.

Since the inductor current IL supplied to the load is increased as the load connected to the output end of the power factor corrector 1 is increased, the current flowing to the capacitor C1 is decreased so that an output voltage Vout is decreased. On the contrary, since the inductor current IL is decreased as the load is decreased, the current flowing to the capacitor C1 is increased so that the output voltage Vout is increased.

When the energy of the inductor L is wholly supplied to the load during the turn-off period of the power switch 11, the diode D1 is disconnected. Then, a drain voltage of the power switch 11 is decreased due to a resonance between the inductor L and a parasitic capacitor (not shown) of the power switch 11. The power switch 11 is turned on after the drain voltage is decreased, and thus the inductor current IL flows again through the power switch 11.

The switch control circuit 2 controls the switching operation of the power switch 11 using an error input voltage INV that corresponds to the output voltage Vout. The switch control circuit 2 samples the error input voltage INV at a time that an AC input is blocked and then supplied to control a soft start operation or an operation start time (hereinafter, referred to as an AC input time) of the power factor corrector 1, and increases a soft start voltage from a start voltage that corresponds to the sampled error input voltage INV during a soft start period.

The error input voltage INV is a voltage divided according to a resistance ratio (R2/(R1+R2)) of the division resistors R1 and R2 from the output voltage Vout. The switch control circuit 2 generates an error voltage COMP using the error input voltage INV and determines a duty of the power switch 11 by comparing the error voltage COMP with a predetermined sawtooth wave signal VSAW. The sawtooth wave signal VSAW is increased with a constant slop during the turn-on period of the power switch 11.

The switch control circuit 2 generates a gate signal VG for controlling the switching operation of the power switch 11. The error input voltage INV is input to a connection pin P1 of the switch control circuit 2 and the gate signal VG is output through a connection pin P2.

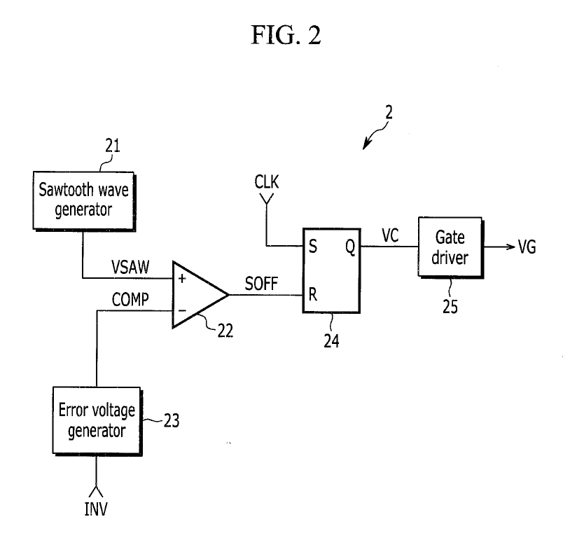

The switch control circuit 2 will be described in further detail with reference to FIG. 2.

FIG. 2 shows the switch control circuit according to the exemplary embodiment of the present invention.

As shown in FIG. 2, the switch control circuit 2 includes sawtooth wave generator 21, a PWM comparator 22, an error voltage generation circuit 23, an SR latch 24, and a gate driver 25.

The sawtooth wave generator 21 generates a sawtooth wave VSAW that increases with a predetermined slop during the turn-on period of the power switch 11.

The PWM comparator 22 generates an off control signal SOFF that determines the duty of the power switch 11 by comparing the sawtooth wave VSAW with the error voltage COMP. The PWM comparator 22 includes an inversion terminal (+) to which the sawtooth wave VSAW is input and a non-inversion terminal (−) to which the error voltage COMP is input. The PWM comparator 22 generates a high-level off control signal SOFF when the sawtooth wave VSAW is higher than the error voltage COMP, and generates a low-level off control signal SOFF when the sawtooth wave VSAW is lower than the error voltage COMP.

The error voltage generation circuit 23 receives the error input voltage INV, samples and holds an error input voltage INV at the AC input time, and generates an error voltage COMP according to a difference between the soft start voltage that increases from the start voltage according to the sampled error input voltage INV to a expiring voltage during the soft start period.

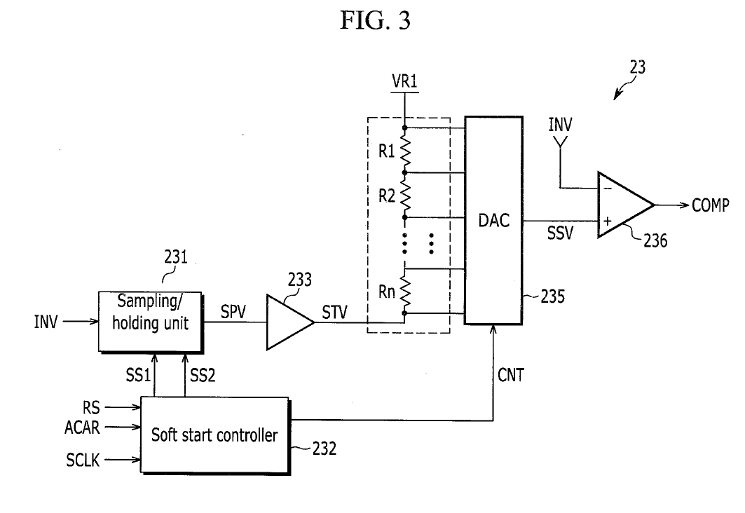

The error voltage generation circuit 23 generates an error voltage COMP according to a difference between the error input voltage INV and the soft start voltage having a predetermined level for a normal period during which the AC input is supplied. The error voltage generation circuit 23 will be described in further detail with reference to FIG. 3 to FIG. 7.

The SR latch 24 includes a set terminal S to which a clock signal CLK is input, a reset terminal R to which the off control signal SOFF is input, and an output terminal Q through which a gate control signal VC is output. The SR latch 24 is synchronized by a rising edge of the clock signal input to the set terminal S and this outputs a high-level signal through the output terminal Q, and is synchronized by a rising edge of a signal input to the reset terminal R and thus outputs a low-level signal. When the set terminal S and the reset terminal R both have low-level inputs, the SR latch 24 maintains a current output.

The clock signal CLK is a signal that determines a switching frequency of the power switch. The SR latch 24 outputs a high-level gate control signal VC at a rising edge of every cycle of the clock signal CLK, and outputs a low-level gate control signal VC at a rising edge time of the off control signal SOFF.

The gate driver 25 generates a high-level gate signal VG according to the high-level gate control signal VC and generates a low-level gate signal VG according to the low-level gate control signal VC.

FIG. 3 shows the error voltage generation circuit according to the exemplary embodiment of the present invention.

As shown in FIG. 3, the error voltage generation circuit 23 includes a sampling/holding unit 231, a soft start controller 232, a voltage buffer 233, a reference voltage generator 234, a digital-to-analog converter (hereinafter, referred to as a DAC) 235, and a power factor correction amplifier 236.

The sampling/holding unit 231 samples an error input voltage INV at the AC input time and holds a sampling voltage SPV according to the sampled error input voltage INV during the soft start period. The sampling/holding unit 231 generates a normal-level sampling voltage SPV when the soft start period is terminated. Operation of the sampling/holding unit 231 is controlled by a first control signal SS1 and a second control signal SS2 transmitted from the soft start controller 232.

The soft start controller 232 is synchronized at the time that the AC input is blocked and then supplied again or the operation start time of the power factor corrector, and controls the soft start period.

The soft start controller 232 receives a reset signal RS, an AC absent release signal ACAR, and a soft clock signal SCLK, determines a sampling time by being synchronized by the reset signal RS or the AC absent release signal ACAR, and counts the soft start period using the soft clock signal SCLK. The soft start controller 232 generates a count result as a counter signal CNT, that is, an n-bit digital signal.

The reset signal RS is a signal that commands restart of the power factor corrector, and the AC absent release signal ACAR is a signal generated when the AC input is supplied. The soft clock signal SCLK is a clock signal having a predetermined frequency for counting of the soft start period.

The sampling/holding unit 231 generates a normal-level sampling voltage SPV while the first control signal SS1 has an enable-level, and generates a sampling voltage SPV according to the error input voltage INV sampled at the AC input time while the second control signal SS2 has an enable-level. According to the exemplary embodiment of the present invention, a time that the second control signal SS2 is sampled is a sampling time.

The first control signal SS1 and the second control signal SS2 are inversed in phase. According to the exemplary embodiment of the present invention, a predetermined dead time may be set to prevent a period during which the first control signal SS1 and the second control signal SS2 simultaneously have the enable-level from being occurred.

The voltage buffer 233 blocks impedance between the sampling/holding unit 231 and the reference voltage generator 234, and stably transmits the sampling voltage SPV as a start voltage STV to the reference voltage generator 234.

The reference voltage generator 234 includes a resistor row formed of a plurality of resistors R1 to Rn coupled in series. A reference voltage VR1 is connected to a first end of both ends of the resistor row (i.e., a first end of the resistor R1), and the start voltage STV is connected to a second end of the resistor row (e.g., a second end of the resistor Rn).

According to the exemplary embodiment of the present invention, the reference voltage VR1 equals to a soft start expiring voltage ENV. However, the present invention is not limited thereto, and one of node voltages between adjacent resistors may be set as the expiring voltage EVN.

Node voltages between adjacent resistors are supplied as soft reference voltages of the DAC 235 from the reference voltage generator 234. In the exemplary embodiment of the present invention, n+1 (n is the number of resistors) soft reference voltages are supplied to the DAC 235 from the reference voltage generator 234 from the start voltage SW to the expiring voltage ENV.

The DAC 235 selects an analog voltage corresponding to the counter signal CNT during the soft start period and outputs a soft start voltage SSV. The analog voltage corresponding to the counter signal CNT is one of the soft reference voltages supplied from the reference voltage generator 234. Not during the soft start period, the DAC 235 outputs the reference voltage VR1 as the soft start voltage SSV.

The power factor correction amplifier 236 generates an error signal COMP by amplifying a difference between the soft start voltage SSV and the error input voltage INV. The error amplifier 236 includes a non-inversion terminal + to which the soft start voltage SSV is input and an inversion terminal (−) to which the error input voltage INV is input.

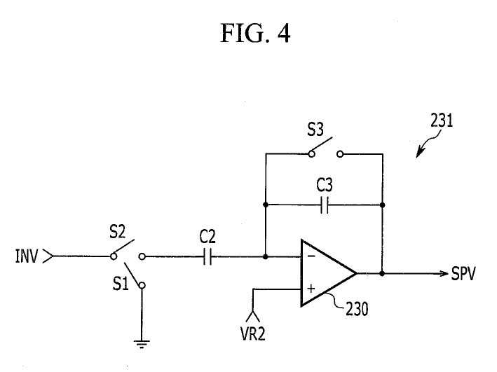

Hereinafter, the sampling/holding unit according to the exemplary embodiment of the present invention will be described with reference to FIG. 4.

FIG. 4 shows the sampling/holding unit according to the exemplary embodiment of the present invention.

As shown in FIG. 4, the sampling/holding unit 231 includes an error amplifier 230, three switches S1, S2, and S3, and two capacitors C2 and C3. The switches S2 and S3 are controlled by the second control signal SS2, and the switch S1 is controlled by the first control signal SS1.

The inversion terminal (−) of the error amplifier 230 is connected with a first end of the capacitor C2, a first end of the capacitor C3, and a first end of the switch S3. The reference voltage VR2 is input to the non-inversion terminal (+) of the error amplifier 230. An output terminal of the error amplifier 230 is connected with a second end of the capacitor C3 and a second end of the switch S3.

A second end of the capacitor C2 is connected with a first end of the switch S1 and a first end of the switch S2, a second end of the switch S1 is grounded, and the error input voltage INV is input to a second end of the switch S2.

For a period during which the AC input is normally supplied, the switches S2 and S3 are turned on and the switch S1 is turned off by the first control signal SS1. Then, the inversion terminal (−) and the output terminal of the error amplifier 230 are connected, and the error amplifier 230 outputs a reference voltage VR2, that is, a voltage of the non-inversion terminal (+).

Since the output voltage VOUT is decreased from a time that the AC input is blocked, the error input voltage INV also starts to decrease. While the AC input is blocked, the switches S2 and S3 are turned on and therefore the error amplifier 230 outputs the reference voltage VR2.

Thus, the sampling voltage SPV input to the voltage buffer 233 during this period is the same as the reference voltage VR2.

The soft start period is started by being synchronized at the AC input time, and during the soft start period, the switch S2 and switch S3 are turned off and the switch S1 is turned on. The error input voltage INV in the AC input time is applied to the second end of the capacitor C2. When the switches S2 and S3 are turned off and the switch S1 is turned on right after the AC input time, the capacitor C3 is formed between the output terminal and the non-inversion terminal (+) of the error amplifier 230 and a voltage at the second end of the capacitor C2 is grounded.

A lateral end voltage of the capacitor C2 at the AC input time is transmitted to the capacitor C3 right after the AC input time. Since the lateral end voltage of the capacitor C2 is VR2-INV and a voltage of the first end of the capacitor C2 is the reference voltage VR2 at the AC input time, the error input voltage INV becomes a voltage at the second end of the capacitor C3. That is, a sampled error input voltage INV of the AC input time is output as the sampling voltage SPV.

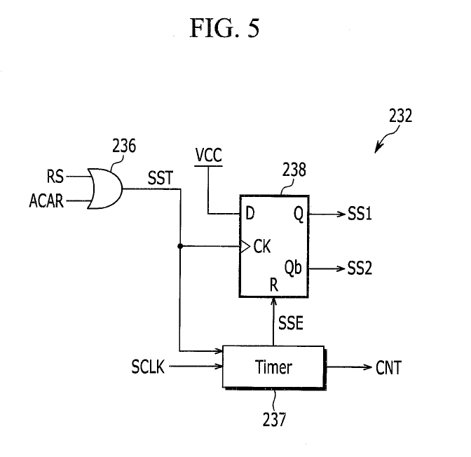

Hereinafter, the soft start controller 232 will be described with reference to FIG. 5.

FIG. 5 shows the soft start controller according to the exemplary embodiment of the present invention.

The soft start controller 232 includes an OR gate 236, a timer 237, and a D flip-flop 238.

The OR gate 236 receives the reset signal RS and the AC absent release signal ACAR, and generates a soft start signal SST. That is, when the AC input is supplied or the reset signal for operation of the power factor corrector is input, the OR gate 236 generates the soft start signal SST. The soft start signal SST starts to drive the timer 237 and the D flip-flop 238.

The timer 237 controls the soft start period. The timer 237 is synchronized by the soft start signal SST and thus starts operation, determines the soft start period by counting the soft clock signal SCLK, and generates a soft start expiring signal SSE that commands expiration of the soft start. The soft start expiring signal SSE resets an output of the D flip-flop 238.

The timer 237 outputs the counting result of the soft clock signal SCLK as a counter signal CNT, that is, an n-bit digital signal. The DAC 235 selects an analog voltage according to a digital value of the counter signal CNT and outputs the selected analog voltage as a feedback signal SSV.

The D flip-flop 238 is enabled by the soft start signal SST and changes an output according to an input of the input terminal D. While the D flip-flop 238 is in the enabled state, a high-level signal and a low-level signal are output respectively through an output terminal Q and an inverse output terminal Qb when the input of the input terminal D is high level. A voltage VCC input to the input terminal D according to the exemplary embodiment of the present invention is high level.

Thus, the D flip-flop 238 is enabled by a high-level soft start signal SST, and outputs a high-level first control signal SS1 and a low-level second control signal SS2 respectively through the output terminal Q and the inverse output terminal Qb.

The D flip-flop 238 is reset by a soft start expiring signal SSE input to the reset terminal R, and outputs a low-level first control signal SS1 and a high-level second control signal SS2 respectively through the output terminal Q and the inverse output terminal Qb.

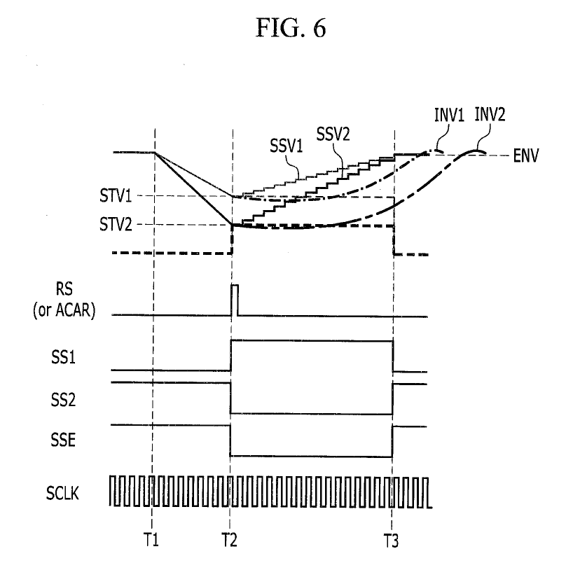

Hereinafter, the operation of the power factor corrector according to the exemplary embodiment of the present invention will be described with reference to FIG. 6.

FIG. 6 is a waveform diagram of signals of the error voltage generation circuit according to the exemplary embodiment of the present invention.

As shown in FIG. 6, the AC input is normally supplied before a time point T1. Since an output voltage VOUT is constantly controlled during a period before the time point T1, the error input voltage INV is constantly maintained.

The AC input is blocked and the output voltage VOUT is decreased at the time point T1, and therefore the error input voltage INV also starts to decrease. A waveform of the error input voltage INV is changed according to a load. For example, FIG. 6 illustrates INV1 and INV2.

Since the decrease slope of the output voltage VOUT is increased as the load is increased, INV1 is an error input voltage INV when the load is relatively low compared to INV2.

At a time point T2, the AC input is supplied. That is, the time point T2 is an AC input time point. In the time point T2, the AC absent release signal ACAR is increased to high level and the soft start signal SST is generated. Then, the D flip-flop 238 is enabled by the high-level soft start signal SST, and generates a high-level first control signal SS1 and a low-level second control signal SS2.

The timer 237 is synchronized with a rising edge of the soft start signal SST at the time point T2 and thus starts a counting operation, and changes a level of the soft start expiring signal SSE to a low level. The soft start expiring signal SSE is maintained in a low level during the soft start period.

The sampling/holding unit 231 samples and holes the error input voltage INV at the time point T2 and outputs sampled and hold error input voltage as a sampling voltage SPV. Through the voltage buffer 233, the sample voltage SPV is transmitted to the reference voltage generator 234 as a start voltage STV.

As shown in FIG. 6, a start voltage STV1 generated from INV1 sampled at the time point T2 and a start voltage STV2 generated from INV2 sampled at the time point T2 are illustrated.

During the soft start period T2-T3, the DAC 235 gradually increases the soft start voltage SSV according to the counting signal CNT from the start voltage SW to the expiring voltage ENV. As shown in FIG. 6, the soft start voltage SSV1 is gradually increased from the start voltage STV1 to the expiring voltage ENV, and the soft start voltage SSV2 is gradually increased from the start voltage STV2 to the expiring voltage ENV.

During the soft start period T2-T3, the voltages held by the sampling/holding unit 231, that is, the start voltages STV1 and STV2 are constantly maintained as shown in the dotted line. The error input voltages INV1 and INV2 are slowly increased according to the soft start operation. During the soft start period T2-T3, the error input voltages INV1 and INV2 are respectively lower than the corresponding soft start voltages SSV1 and SSV2. Thus, a problem of occurrence of a period during which the switching operation is not performed may be solved.

At the time point T3, the timer 237 increases the soft start expiring signal SSE that instructs the soft start termination to high level according to the counting result of the soft clock signal SCLK. Then, the D-flip-flop 238 is reset and thus generates a low-level first control signal SS1 and a high-level second control signal SS2.

After the time point T3, the sampling/holding unit 231 outputs the reference voltage VR2 as the sampling voltage SPV, and the DAC 235 outputs the soft start expiring voltage ENV as the soft start voltage SSV.

The sampling/holding unit 231 according to the exemplary embodiment of the present invention may be simply realized by a switch S4 switched by the second control signal SS2 and a capacitor C4.

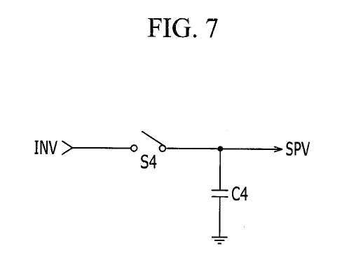

FIG. 7 is an exemplary variation of the sampling/holding unit according to the exemplary embodiment of the present invention.

The switch S4 includes a first end to which the error input voltage INV is input and a second end connected with the capacitor C4. A voltage of a node of a first end of the capacitor C4 and the second end of the switch S4 is the sampling voltage SPV.

As described, the error input voltage corresponding to the output voltage is sampled at the time that the AC input supply is started, and the soft start operation is controlled according thereto so that problems that the switching operation is not performed during the soft start period and the change of the soft start period according to the load can be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

power factor corrector 1,
switch control circuit 2,
power switch 11,
inductor L
bridge diode 12
diode D1,
capacitor (C1, C2, C3, C4)
division resistor R1 and R2,
saw-tooth wave generator 21,
PWM comparator 22
Error voltage generation circuit 23,
SR latch 24,
gate driver 25,
Voltage buffer 233
sampling/holding unit 231,
soft start controller 232,
reference voltage generator 234
digital-to-analog converter 235,
power factor correction error amplifier 236
switch S1, S2, and S3,
error amplifier 230,
OR gate 236,
timer 237
D flip-flop 238

What is claimed is:

1. An error voltage generation circuit generating an error voltage using an error input voltage corresponding to an output voltage of a power factor corrector, comprising
a sampling/holding unit sampling an error input voltage at a supply time point of an AC input to the power factor corrector and holding a sampling voltage according to the sampled error input voltage during a soft start period, and
a digital-analog converter (DAC) generating a soft start voltage increasing from a start voltage corresponding to the sampling voltage.

2. The error voltage generation circuit of claim 1, further comprising a soft start controller being synchronized at the AC input supply time point or at an operation start time point of the power factor corrector and generating a count signal counting the soft start period,
wherein the DAC generates a soft start voltage increasing from the start voltage to a predetermined expiring voltage according to the count signal during the soft start period.

3. The error voltage generation circuit of claim 2, wherein the error voltage generation circuit further comprises a reference voltage generator receiving the start voltage and generating a plurality of reference voltages between the start voltage and the expiring voltage,
the DAC selects the start voltage, the plurality of reference voltages, and the expiring voltage according to the count signal during the soft start period, and
the soft start controller generates the count signal by counting a predetermined soft clock signal.

4. The error voltage generation circuit of claim 3, wherein the soft start controller comprises
a timer synchronized at the AC input supply time point or the operation start time point of the power factor corrector and generating the count signal by counting the soft clock signal, and
a D flip-flop synchronized at the AC input supply time point or the operation start time point of the power factor corrector and activating the sampling/holding unit.

5. The error voltage generation circuit of claim 4, wherein the D flip-flop generates a first control signal and a second control signal that control a sampling operation of the sampling/holding unit during the soft start period, and the sampling/holding unit blocks the error input voltage according to the second control signal, generates the sampling voltage, and changes an input of the sampling/holding unit to a predetermined first reference voltage according to the first control signal.

6. The error voltage generation circuit of claim 5, wherein the sampling/holding unit comprises:
a first switch performing a switching operation according to the first control signal and having a first end connected to the first reference voltage;
a second switch performing a switching operation according to the second control signal and having a first end connected to the error input voltage;
a first capacitor having a first end connected to a second end of the first switch and a second end of the second switch;
an error amplifier including a first input terminal connected to the second end of the first capacitor and a second input terminal to which a second reference voltage is input;
a second capacitor connected between an output terminal and the first input terminal of the error amplifier; and
a third switch connected between the output terminal and the first input terminal of the error amplifier, and
a voltage of the output terminal of the error amplifier is the sampling voltage.

7. The error voltage generation circuit of claim 4, wherein the D flip-flop generates a control signal that controls the sampling operation of the sampling/holding unit during the soft start period, and the sampling/holding unit blocks the error input voltage according to the control signal and generates the sampling voltage.

8. The error voltage generation circuit of claim 7, wherein the sampling/holding unit comprises
a switch performing the switching operation according to the control signal and having a first end connected to the error input voltage and a capacitor including a first end connected to a second end of the switch, and
the sampling voltage is a voltage of the first end of the capacitor.

9. The error voltage generation circuit of claim 3, wherein the reference voltage generator comprises a resistor row formed of a plurality of resistor coupled in series between a first end to which the start voltage is input and a terminal where the expiring voltage is generated.

10. The error voltage generation circuit of claim 9, wherein the DAC selects a corresponding voltage among voltages of a plurality of nodes formed in the resistor row according to the count signal.

11. The error voltage generation circuit of claim 1, further comprising a power factor correction error amplifier generating an error signal according to a difference between the soft start voltage and the error input voltage.

12. A switch control circuit receiving an AC input and controlling an operation of a power switch of a power factor corrector that generates an output voltage, comprising:
an error voltage generation circuit sampling and holding an error input voltage corresponding to the output voltage at an AC input supply time point after the AC input is blocked or an operation start time point of the power factor corrector and generating an error voltage according to a difference between a soft start voltage increasing to a predetermined expiring voltage from a start voltage according to the sampled error input voltage and the error input voltage during a soft start period, and
a PWM comparator controlling a duty of the power switch using the error voltage.

13. The switch control circuit of claim 12, wherein the error voltage generation circuit comprises
a sampling/holding unit sampling an error input voltage at the AC input supply time point and holding a sampling voltage according to the sampled error input voltage during the soft start period, and
a digital to analog converter (DAC) generating a soft start voltage increasing from a start voltage corresponding to the sampling voltage.

14. The switch control circuit of claim 13, wherein the error voltage generation circuit further comprises a soft start controller controlling the sampling operation by being synchronized at the AC input supply time or the operation start time point of the power factor corrector and generating a count signal counting the soft start period, and
the DAC generates a soft start voltage increasing from the start voltage to a predetermined expiring voltage according to the count signal during the soft start period.

15. The switch control circuit of claim 14, wherein the error voltage generation circuit further comprising a reference voltage generator receiving the start voltage and generating a plurality of reference voltages between the start voltage and the expiring voltage,
the DAC selects the start voltage, the plurality of reference voltages, and the expiring voltage according to the count signal during the soft start period, and,
the soft start controller generates the count signal by counting a predetermined soft clock signal.

16. The switch control circuit of claim 15, wherein the soft start controller comprises
a timer synchronized at the AC input supply time point or the operation start time point of the power factor corrector and generating the count signal by counting the soft clock signal, and
a D-flilflop synchronized at the AC input supply time point or the operation start time point of the power factor corrector to activate the sampling/holding unit.

17. A power factor corrector generating an output voltage by receiving an AC input, comprising:
an inductor to which an input voltage rectified from the AC input;
a power switch connected to the inductor to control generation of the output voltage; and
a switch control circuit sampling and holding an error input voltage corresponding to the output voltage at the AC input supply after the AC input is blocked or the operation start time point of the power factor corrector, generating an error voltage according to a difference between a soft start voltage including from a start voltage according to the sampled error input voltage to a predetermined expiring voltage and the error input voltage, and controlling a duty of the power switch using the error voltage.

18. The power factor corrector of claim 17, wherein the switch control circuit comprises
a sampling/holding unit sampling an error input voltage at the AC input supply time point and holding a sampling voltage according to the sampled error input voltage during the soft start period, and
a digital to analog converter (DAC) generating a soft start voltage increasing from a start voltage corresponding to the sampling voltage.

19. The power factor corrector of claim 18, wherein the switch control circuit further comprises a soft start controller controlling the sampling operation by being synchronized at the AC input supply time point or the operation start time point of the power factor corrector and generating a count signal counting the soft start period, and
the DAC generates a soft start voltage increasing from the start voltage to a predetermined expiring voltage according to the count signal during the soft start period, and

20. The power factor corrector of claim 19, wherein the switch control circuit further comprises a reference voltage generator receiving the start voltage and a plurality of reference voltage between the start voltage and the expiring voltage,
the DAC selects the start voltage, the plurality of reference voltage, and the expiring voltage according to the count signal during the soft start period, and,
the soft start controller generates the count signal by counting a predetermined soft clock signal.
